(19) United States
(12) Patent Application Publication
(10) Pub. No.: US 2016/0109284 A1
(43) Pub. Date: Apr. 21, 2016

(54) METHOD AND DEVICE FOR MODELLING ROOM ACOUSTIC BASED ON MEASURED GEOMETRICAL DATA

(71) Applicant: Aalborg Universitet, Aalborg Ø (DK)

(72) Inventors: Dorte Hammershøi, Aalborg (DK); Søren Krarup Olesen, Aalborg Ø (DK); Milos Markovic, Ni&scaron; (RS)

(21) Appl. No.: 14/777,661

(22) PCT Filed: Mar. 18, 2014
(86) PCT No.: PCT/DK2014/050064

§ 371 Date: Sep. 16, 2015

(30) Foreign Application Priority Data
Mar. 18, 2013 (DK) PA 2013 70158

(51) Int. Cl. G01H 7/00

(52) U.S. Cl. CPC G01H 7/00

(57) ABSTRACT

The invention provides a method for generating an output indicative of acoustical sound transmission in a room. By using e.g. a point cloud representation of an acoustic environment, it is possible to calculate its acoustics from the interior information obtained from the depth camera. This approach is suitable e.g. for run-time applications since it is not based on an audible excitation that can disturb running audio. Also, the point-cloud model can be updated in real time according to the scene changes detected by depth-camera. This allows efficient acoustical simulation of dynamic, interactive environments. Although only geometrical information of a room is provided, high amount of surface details leaves possibility for implementation of material recognition algorithms that involve semantic mapping. This can provide information of reflective properties of surfaces or objects at a point level. Also, a high amount of details allows a good approximation of complex geometries, e.g. porous materials, and rough surfaces, thus a more natural simulation of wave phenomena like diffraction and scattering is possible.

### FIELD OF THE INVENTION

The invention relates to the field of acoustics. More specifically, the invention provides a method and a device for modelling room acoustics based on geometrical data measured in a room, e.g. cloud point data obtained by an infrared depth camera. The invention can be used for a number of applications, such as rendering of an acoustic environment in real-time, for auralization, or for calculation of acoustic metrics.

### BACKGROUND OF THE INVENTION

Users' expectations of a present-day communication technology go beyond services that give a possibility of long distance, real time conversation. Communication with the feeling of being together and sharing the same environment is desired. See, e.g. [Y. A. Huang, J. Chen, J. Benesty, “Immersive audio schemes”, IEEE Signal Processing Magazine, 28, 20-32 (2011)].

Spatial sound plays an important role if a concept of presence at the remote location is desired. Different techniques are used for spatial sound rendering [D. R. Begault, “3D sound for virtual reality and multimedia”, (AP Professional, Cambridge, Mass., 2000)]. Most of them are based on the same principle: modelling of the sound field and reproducing the rendered sound.

Modelling relies on knowledge of sound propagation behavior in the acoustical space—room acoustics simulation, while rendered sound reproduction involves binaural cues of the human hearing [H. Moller, “Fundamentals of Binaural Technology”, Applied Acoustics, 36, 128-171 (1992)]. Fast room geometry acquisition suitable for the real-time room acoustic simulations is required when dynamic, interactive environments are to be acoustically rendered.

### SUMMARY OF THE INVENTION

Thus, according to the above description, it may be seen as an object of the present invention to provide a method and a system for providing an acoustical description of a room capable of providing real-time acoustical rendering using a limited amount of processing power.

In a first aspect, the invention provides a method for generating an output indicative of acoustical sound transmission in a room, the method comprising
receiving geometrical data representing a scanning of the room, such as an output data from an depth camera,
generating a numerical representation of the room in response to the geometrical data, such as a voxel-based representation of the room,
applying at least one acoustical property to elements of the numerical representation of the room to obtain an acoustical room model, and
calculating the output indicative of the acoustical sound transmission in the room in response to the acoustical room model.

Such method is advantageous for acoustical rendering since it provides the possibility of establishing a simple voxel-based acoustical room model which allows real-time updating of acoustical sound transmission, e.g. for binaural virtual reality applications. In a simple voxel-based description of a room, where voxels are acoustically represented as either “air” or “reflecting boundary”, it is possible to provide a simple description of acoustical sound transmission between a sound source and receiver in the room which can easily be real-time updated, e.g. taking into account movement of one or more of: objects present in the room, the sound source, and the receiver. Thus, in one scenario the geometrical scanning is performed once, but in other scenario the scanning device provides a stream of geometrical data for dynamic processing, thus allowing detection of moving objects or other changes influencing sound transmission properties of the room, e.g. opening of a door or window in the room.

The geometrical data can be applied by expensive laser scanning equipment, or different types of precision cameras. However, low cost alternatives are available like the Kinect™ device which uses an infra-red structured light pattern that allows depth measurements with a high resolution (3 mm point-to-point distance), and it provides depth frames registered to RGB frames. In some applications the full resolution can be used, however in some applications a more coarse resolutions may suffice, and thus limit the required processing power for real-time rendering.

Apart from the advantages for real-time applications, the method can be used as an alternative to other method for obtaining acoustical models of an existing room, e.g. for calculation of statistical acoustical measures, e.g. reverberation time, speech intelligibility index etc. However, the method may be used as an alternative to or an addition to acoustical measurements in a room. E.g. the method may supplement a measurement of reverberation time in a room, thus allowing easy establishment of an acoustical room model which can be used to predict acoustical effects of changes of sound absorbing properties of boundaries or objects in the room. E.g. the method may be used to generate an input to an acoustical room model software, such as ODEON™. In other applications, the method may be used to generate input to a room correction unit. E.g. a room correction unit forming part of a hi-fi equipment such as a surround sound receiver or studio equipment, with the purpose of providing a suitable spectral equalizing serving to compensate for the acoustical properties of a room, thereby improving loudspeaker sound reproduction in the room, especially below 1 kHz.

It is to be understood that ‘room’ any type of environment with any kind of acoustical obstacles, such as boundaries in the form of walls, ceiling and floor, and/or any object which may influence sound transmission between a sound source and a receiver present in the environment.

In a preferred embodiment, the numerical representation comprises a voxel-based representation comprising a plurality of voxels each being assigned with an acoustical property. Especially, the acoustical property can be selected between at least two different values, such as a first value indicative of a voxel being acoustically transparent and a second value indicative of a voxel being acoustically reflecting, i.e. voxels being either “air” or “reflective”. Alternatively, “air” or “X % absorption”, where X can be selected as a single value. In other embodiments, voxels can have additional properties, e.g. voxels spatially representing a boundary or another object, may have assigned a frequency depending set of sound absorption coefficients. Depending on the type of acoustical properties selected in the model, and the selected spatial resolution, it is possible to provide a rather coarse and simple model, or a more acoustically detailed model.

The method may comprise performing a segmentation in response to the geometrical data, so as to identify a plurality of objects in the room each comprising a plurality of elements of the numerical representation, such as identifying boundaries of the room. The raw data from the scanning device, e.g. a Kinect™ device, may be processed with the purpose of improving the acoustical room model by changing the numerical representation of geometry of identified accordingly, e.g. by smoothing the data representing plane surfaces, such as walls and floor of the room etc.

In a special embodiment, the method includes applying properties indicative of acoustical absorption to elements of the numerical representation of the room, where an image processing algorithm is to geometrical data and/or a photo taken in the room, so as to automatically identify different objects or surfaces with similar properties in accordance with parameters in the photo.

By “photo” is understood, e.g. in connection with the Kinect™, RGB information of each point which provides a texture of a surface that can be used for pattern recognition in order to predict a scanned material and thus its acoustical properties. E.g. colors and patterns in the photo may be used to predict acoustical properties of a given surface or object, such as acoustical absorption, thus allowing automatically assigning acoustical properties to elements of the numerical representation of the room accordingly. Especially, acoustical absorption data may be assigned to an object in accordance with a database of acoustical absorption data. In a simple embodiment, the geometrical data and/or a photo is processed with respect to identifying surfaces or objects with similar material, determining which type of material it is by selecting between a number of predetermined definitions materials, and assigning prestored acoustical properties for that type of material to geometrical elements representing the object in the model.

In one embodiment, the step of calculating the output indicative of the acoustical sound transmission in the room comprises calculating a statistical acoustical measure indicative of acoustical sound transmission in the room, such as one of: reverberation time (e.g. T₆₀), clarity, early decay time (EDT), speech intelligibility (e.g. RASTI), or any measure or variants thereof, as known by the skilled person. Such embodiment allows easy verification of acoustical properties of a room, e.g. reverberation time, without the need for acoustical measurements. Thus, based on the geometrical input from a scanning device, acoustical properties e.g. absorption coefficients are applied manually or automatiacally at least for the major objects and surfaces in the room.

In one embodiment, the step of calculating the output indicative of the acoustical sound transmission in the room comprises generating an output indicative of an impulse response (Room Impuse Response, RIR) representing sound transmission from a source position to a receiver position in the room. With such representation, which can be based on various acoustical models as known by the skilled person, it is possible to provide an auralization based on the geometrical representation and possibly acoustical properties (e.g. absorption coefficients, scattering effect etc.) of elements of the geometry. Especially, it may be preferred to generate the output in the form of a list of single reflections including arrival time and arrival angle at the receiver position. Such representation allows binaural auralization, e.g. by generating in response a Binaural Room Impulse Response (BRIR), which can be convolved with a sound input singal to generate a binaural output signal. In a special embodiment, generation of a RIR or BRIR is combined with a voxel-based geometrical representation and application of a discrete ray tracing method to arrive at the RIR or BRIR. Such embodiment is suitable for dynamic updating of the RIR or BRIR in response to one or more of: source position, receiver position, receiver orientation, objects moving in the room (e.g. detected based on a dynamic updating of the geometrical representation of the room).

In one scenario, a user is provided with a binaural auralization signal based on detecting the user's position and orientation relative to the room geometry, and thus in such embodiment, the binaural auralization signal can be dynamically updated by updating the RIR or BRIR in response to the user's moving around and turning of his/her head. Using a discrete ray tracing method on the voxel-based data, it is possible to provide an acoustical room model which can be updated in real-time in response to the above-mentioned inputs, with a limited processing power.

In one embodiment, the output comprises data in a parametric format, such as data indicative of discrete sound waves in the room, thus allowing generating e.g. RIR or BRIR in response thereto, as mentioned above.

One embodiment comprises applying parameters indicative of acoustical diffusion and/or scattering to elements of the numerical representation of the room. Such additional acoustical parameters, e.g. in combination with sound absorption coefficients, allow a detailed acoustical description of the room.

One embodiment comprises performing a discrete ray tracing algorithm in response to the acoustical room model. As mentioned above, especially in combination with a voxel-based geometrical representation, discrete ray tracing is suitable for dynamically updating the acoustical sound transmission properties in the model of the room. Thus, especially the method may comprise receiving a stream of geometrical data representing respective scannings of the room, and dynamically updating a discrete ray tracing representation accordingly.

One embodiment comprises receiving a stream of position data indicative of an acoustical receiver position in the room, and dynamically calculating the output indicative of acoustical sound transmission from an acoustical source position to the acoustical receiver position in the room accordingly. Especially, the method may comprise dynamically calculating an output indicative of an impulse response (RIR) representing sound transmission from the source position to the receiver position in the room.

One embodiment comprises generating an acoustical output signal in response to a calculated acoustical sound transmission from a source position to a receiver position in the room, in accordance with the acoustical room model. Especially, the method comprises generating a binaural output signal in response to a calculated acoustical sound transmission from a source position to a receiver position an orientation in the room, in accordance with the acoustical room model.

One embodiment comprises applying a numerical method to the numerical representation of the room. Especially such numerical method may comprises one or more of: a Boundary Element Method, a Finite Element Method, and a Finite Difference Equation method.

One embodiment comprises receiving the geometrical data from a scanning device, e.g. scanning camera, together with a position where the scanning device was positioned in the room, when the geometrical data were measured. This allows e.g. combination of geometrical data obtained from two or more scanning device positions in the room, e.g. to cover a large room and/or cover rooms with geometries which can not be covered by scanning from one single position. Further, the scanning device may have an angularly limited scanning window which necessitates more positions and optionally also different scanning device orientations, to allow scanning of the full room geometry. Thus, especially the method comprises receiving a plurality of geometrical data from a scanning device obtained at respective scanning positions in the room. Preferably, such geometrical data are then incorporated into one combined room model, taking into account the position of the scanning device where the geometrical data, typically in relative coordinates, where the scanning was performed.

The scanning device generating the geometrical data may especially be one of: an infrared depth sensor, a laser scanning device, an ultrasound scanning device, and a 3D camera. Preferably, the scanning device is capable of generating an output signal indicative of 3D coordinates of boundaries detected in the scanned spaced, at a given resolution. The Kinect™ device is a preferred device as an example of a scanning device which can provide data for the method according to the first aspect. Preferably, the output from the scanning device is translated into point cloud data, see e.g. ‘www.pointclouds.org’.

In a second aspect, the invention provides system comprising
an input arranged to receive geometrical data representing a scanning of a 35 room, such as an output data from a depth camera, and
a processor arranged
to generate a numerical representation of the room in response to the geometrical data, such as a voxel-based representation of the room,
to apply at least one acoustical property to elements of the numerical representation of the room to obtain an acoustical room model, either by manually or automatically entering of data, and
to calculate an output indicative of the acoustical sound transmission in the room in response to the acoustical room model.

In a third aspect, the invention provides use of the method or system according to the first or second aspects for one of: a virtual reality scenario, a game, teleconferencing, tele-surgery, tele-teaching, sharing of social events, acoustical de-reverberation, acoustical spectral room correction, and auralization in architectural planning.

In a fourth aspect, the invention provides a non-transitory, computer readable storage medium with a computer executable program code adapted to perform the method according to the first aspect.

It is appreciated that the same advantages and embodiments described for the first aspect apply as well for the second, third and fourth aspects. Further, it is appreciated that the described embodiments can be intermixed in any way between the mentioned aspects.

In still another aspect, the invention provides a method for generating an output indicative of radio-wave transmission in a room, the method comprising
receiving geometrical data representing a scanning of the room, such as an output data from an depth camera,
generating a numerical representation of the room in response to the geometrical data, such as a voxel-based representation of the room,
applying at least one acoustical and/or radio-wave transmission property to elements of the numerical representation of the room to obtain a radio-wave room model, and
calculating the output indicative of the radio-wave transmission in the room in response to the radio-wave room model.

It is known that there is a similarity in the “reverberation time” acoustically and radiowave-wise, especially with respect to energy distribution of a radio wave in a room. The above-mentioned method utilizes this fact. It has been suggested to estimate the properties of the environment with respect to radio propagation by measuring the acoustical impulse response. So, in one embodiment, the radio-wave room transmission in the room is derived based on a radio-wave room model based solely on acoustical properties.

Such embodiments may be valuable for the intelligent power control of WiFi networks. Especially, the estimation of room acoustical parameters may include or be exchanged by one or more numerical functions of radio-wave equation. The radio-wave equation includes preferably a transversal component in a given propagation, in embodiments requiring a high detail in the numerical implementation.

### BRIEF DESCRIPTION OF THE FIGURES

The invention will now be described in more detail with regard to the accompanying figures of which

FIG. 1 illustrates a block diagram of elements of one embodiment,

FIG. 2 illustrates a block diagram of a system embodiment,

FIGS. 3-5 illustrate graphics of different geometrical representations of a room: FIG. 3: 3D point cloud obtained from a camera placed in the centre of a room and rotated around a vertical axis, FIG. 4: triangular mesh, and FIG. 5: uniform voxel grid representation,

FIG. 6 illustrates an example of a cloud point representation of a room, and

FIG. 7 illustrates elements of a method embodiment.

The figures illustrate specific ways of implementing the present invention and are not to be construed as being limiting to other possible embodiments falling within the scope of the attached claim set.

### DETAILED DESCRIPTION OF EMBODIMENTS

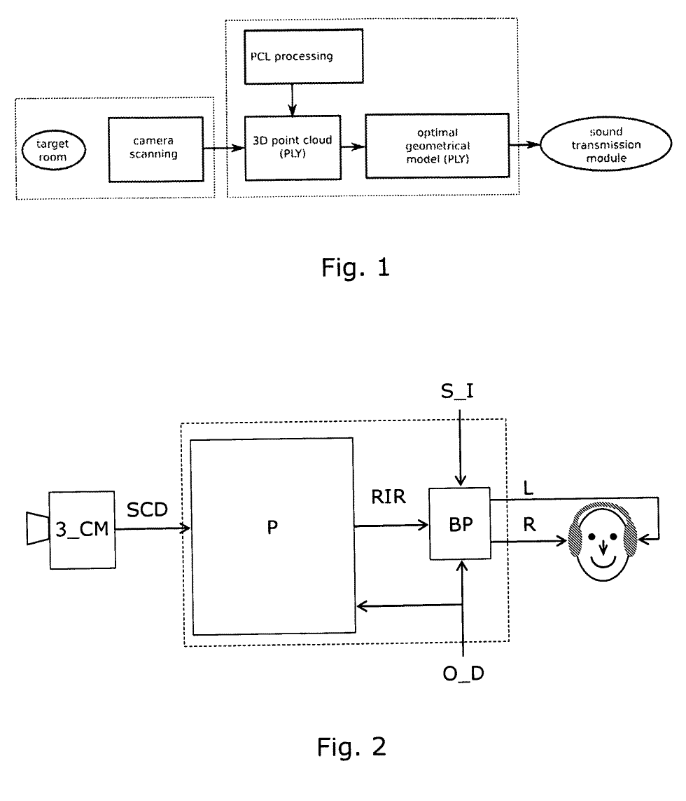

FIG. 1 illustrates an embodiment where a depth camera, e.g. Kinect™device, provides data that allows a 3D cloud point data representation of the room. The whole procedure from a room scanning to the sound transmission module of a room acoustics modelling software comprises two steps. First, the room interior is scanned with the depth camera (Kinect™) using 3D scanning software. Then, the 3D point cloud of the room is processed using the Point Cloud Library (PCL) [www.pointcloud.org], in order to make an optimal room geometrical model for the sound transmission calculation.

The proposed method is independent of the input scanning device (“depth camera”). In general, all scanning devices that provide a boundary description of a scanned room interior can be used to obtain a 3D point cloud model. Still, there are several commercially available types of cameras that employ different techniques. Cameras that can acquire a continuous stream of depth images are available. Most of such scanning devices provide RGB information of the scanned surfaces which can be used for visual rendering in applications where this is desired. That allows simultaneous rendering of the visual scene and the geometry acquisition needed for the acoustical simulation. Also it opens a possibility of the visual data utilization for recognition of the scanned surface material and thus acquisition of its acoustical properties [D. Filiat, et al. “RGBD object recognition and visual texture classification for indoor semantic mapping”, Proceedings of the 4th International Conference on Technologies for Practical Robot Applications, (Woburn, Mass., USA, 2012)], thereby applying such acoustical properties automatically in the acoustical room model.

Three different camera technologies are represented in commercial products: stereo vision exploited in Bumblebee XB3™ camera (SV, three RGB cameras), structured light used in Kinect™ for Xbox360™ (SL, one RGB sensor, one infra-red projector, one infra-red sensor) and time of flight employed in PMD CamCube™ (ToF, using light pulses). All of them provide geometrical description of the boundaries while the visual output is different. The Kinect™ device can densely cover the full scene with its infra-red structured light pattern and thus provides depth measurements with a high resolution (3 mm point-to-point distance). The obtained homogeneous depth map is associated with a colour frame which allows merging the visual and acoustical rendering. The Kinec™ is used as a standard device in the EU project BEAMING. See e.g. [D. Scharstein, R. Szeliski, “High-accuracy stereo depth maps using structured light”, Proceedings of IEEE Computer Society Conference on Computer Vision and Pattern Recognition, (Madison, Wis., USA, 2003)], and [C. Beder, et al. “A Comparison of PMD-Cameras and Stereo-Vision for the Task of Surface Reconstruction using Patchlets”, Proceedings of IEEE Computer Society Conference on Computer Vision and Pattern Recognition, (Minneapolis, Mn., USA, 2007)].

FIG. 2 illustrates a block diagram of a system embodiment, where the described method is used to provide a binaural output signal L, R thus allowing a user to have the acoustic input allowing the user to listen to artificially generated sound creating the feeling of being present in a room which has been scanned with a 3D camera 3_CM, e.g. the Kinect™ device. The raw scanning data SCD from the camera 3_CM is applied to a processor P which is prorammed to perform a suitable processing, such as explained in connection with the method embodiments, i.e. to generate a numerical representation of the room in response to the geometrical data, to apply an acoustical property to elements of the numerical representation of the room to obtain an acoustical room model, and to calculate an output indicative of the acoustical sound transmission in the room in response to the acoustical room model.

In the embodiment of FIG. 2, the processor P is programmed to calculate a room impulse response RIR as output in the form of data representing a list of acoustic waves incident from a source position at a receiver position, including information regarding incidence angle and arrival time. This data RIR is then applied to a binaural processor BP which receives the room impulse response data RIR, as well as a sound signal input S_I, and a stream of data indicating an orientation O_D of the user, e.g. also the user's 3D position within the room. Thus, such system allows tracking of the user moving around in the room, and thereby capable of generating binaural signals L, R to the user corresponding to the left and right ear signals, if the user was present in a location within the room, and with sound S_I from a receiver position within the room. The binaural processor BP applies Head-Related Transfer Functions (HRTFs) to the sound input S_I in accordance with the RIR data, i.e. left and right outputs are generated in response to each incoming sound wave by applying appropriate HRTFs corresponding to the angle of incidence of the sound wave, taking into account the orientation O_D of the user relative to the room. With e.g. a discrete ray tracing method implemented on the processor P, such system shown in FIG. 2 can be used for real-time rendering applications, e.g. virtual reality, tele presence etc. The processor P may be implemented as a Personal Computer, or a dedicated device, or a combination thereof.

FIGS. 3-5 illustrate graphically with an example various representations of the geometry of a room Kinect™ device. A room can be scanned with Kinect™ device in two different ways. The first one involves the device placed in the middle of the room and rotated around the vertical axis, while for the second one the device is moved within the room.

FIG. 3 illustrates result of a scanning by the first approach, which is applicable for any room geometry, and it does not require a human operator, since the device can be mounted on an automatic rotating platform. The scanning procedure takes approximately two minutes. However, this procedure may create shadows, i.e. areas which are shadowed by other surfaces and not visible from the camera standing point are not scanned and thus, the model contains “holes” which is seen in FIG. 3. Also, due to the camera's angle of view, blind spots exist below and above the camera standing point leaving the model without data in these areas. This can be solved with additional processing of the obtained data by a surface (plane) recognition algorithm. When the planes are recognised a model can be supplemented with the artificial data that fit the existing planes.

An alternative is to have the camera move through the room and not just rotate. That will provide more details from different angles. There is no need for additional plane fitting, but a movable sensor requires scanned scenes to be registered in the same model which takes time and slows down the scanning procedure. Also, a human operator is needed to control the scanning and decide on the model quality by visual observation while the scanning takes place.

In one embodiment, autonomous exploration of a field may be implemented with a mobile robot, e.g. with wheels or even a flying robot, with the Kinect™ mounted thereon. Such mobile robot can be used in construction of a 3D map of complex environments. See e.g. [D. Filiat, et al. “RGBD object recognition and visual texture classification for indoor semantic mapping”, Proceedings of the 4th International Conference on Technologies for Practical Robot Applications, (Woburn, Mass., USA, 2012)].

The depth sensor of the Kinect™ device provides a set of points in a three-dimensional coordinate system which represents scanned surfaces of the room interior. These points are stored in 3D point cloud data formats, well known in the field of computer graphics. The most used formats are PCD (Point Cloud Data) and PLY (Polygon File Format). They have a similar structure with a header where a variety of model properties at the level of points can be defined, e.g. (x,y,z) coordinates of the vertices, RGB triple of a point colour, a number of element vertex, (x,y,z) coordinates of the sensor position, a normal based on a certain number of neighbour points etc. Second part of the data format is a list where each row represents the values of the point's properties defined in the header. These values can be given as ASCII or a binary file formats.

An example of a PLY file obtained from the sensor output after scanning the room is shown below:
format ascii 1.0
element vertex 4998006
property float x
property float y
property float z
property float nx
property float ny
property float nz
property uchar red
property uchar green
property uchar blue
element face 3332004
property list uchar uint vertex_indices
end_header
−0.309623 2.33571 2.17339 −0.908879 −0.297005 −0.292794 141 128 110
−0.306158 2.34149 2.17819 −0.908879 −0.297005 −0.292794 141 128 110
−0.300281 2.34501 2.17541 −0.908879 −0.297005 −0.292794 141 128 110
−0.297869 2.34276 2.16782 −0.908879 −0.297005 −0.292794 141 128 110
−0.301334 2.33699 2.16302 −0.908879 −0.297005 −0.292794 141 128 110
−0.307211 2.33347 2.1658 −0.908879 −0.297005 −0.292794 141 128 110

Free software for 3D scanning called Scanect is used. The resulting PLY contains 4998006 vertices represented by ASCII and defined with (x,y,z) coordinates. In addition, position of the sensor for each point is provided (nx,ny,nz), as well as its colour (RGB). Position information of the sensor allows it to be moved through the room while the data are registered on the same model.

The Kinect output is post-processed in order to obtain a 3D point-cloud model of the room. Different post processing is applied for the optimal 3D point-cloud models to be used as an input for a sound transmission module of a different physically based room acoustics modelling methods. In general, granular representation of a room's inner surfaces makes it possible to have a high level of details when creating a geometry model. A high density of points makes it possible to recognize fine details and sharp edges of the surfaces as well as transitions between adjacent areas. Using a different resolution for a room model, it is possible to take into account any frequency-dependent geometry. Thus, on the basis of the original model, a downsampled point-cloud models can be created with less details, e.g. for low frequency simulations. Also, an advantage of a point-based geometry representation is an ability to store information about acoustical properties of each point directly in the 3D point-cloud model just as another property of the PLY header. Eventually, this can facilitate calculation of the sound transmission within the room.

FIG. 4 shows an example of a triangulation mesh representation for numerical acoustical methods. The point-cloud model can be efficiently used to create such triangulation mesh. PCL provides a surface triangulation algorithm of a point cloud with normals to create a triangle mesh. It is based on projections of the local neighbourhoods. By maintaining a list of points from which the mesh can be grown and extending it until all possible points are connected [3D scanning software, http://skanect.manctl.com/], a concave hull can be created that represents room boundaries and the inner surfaces. The planar triangles that the hull is made of enable analytical integration when the acoustical boundary conditions are set. For other numerical methods, a whole 3D model including boundaries, inner surfaces but also the inner empty space is divided into small space units—voxels. Different type of voxels (with and without points of the point-cloud model) define a space grid that can be used in element based modelling, e.g. the finite element method.

Two approaches for geometrical simulations are presented. The first one is more conventional and involves plane recognition and surfaces' normal estimation. PCL is used in order to define important plains/surfaces for the acoustical simulation (walls, floor, ceiling . . . ). Then, for all surfaces of interest, normals are estimated according to the defined neighborhood of a point where the normal is calculated. In this way, a set of normals from the same surface can be obtained only by defining different neighborhood size and thus considering the level of details. This can be useful when a frequency dependent simulation of a reflection is desired. A 3D model defined in this way is useful for standard image source or ray-tracing method.

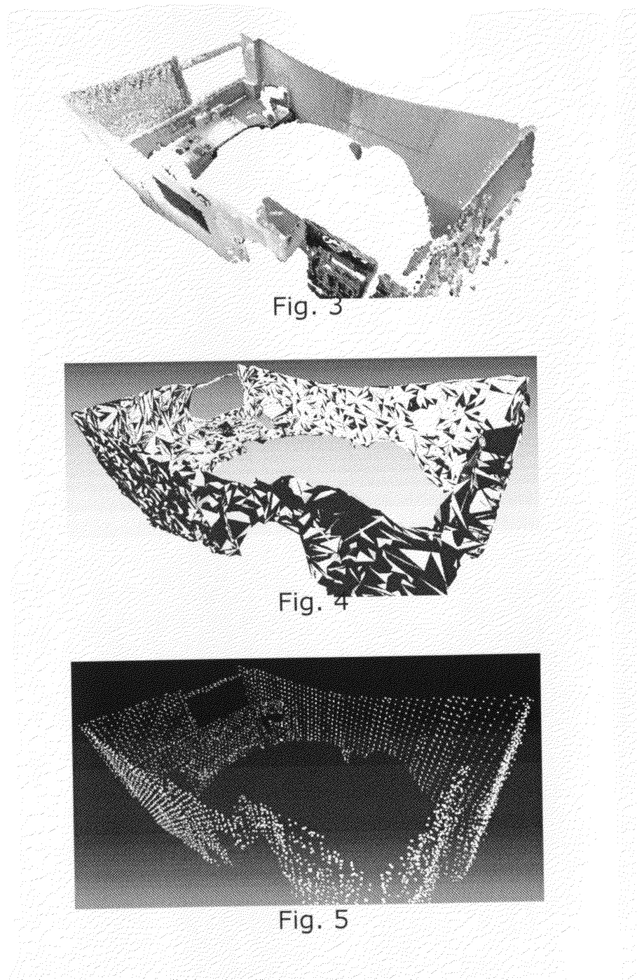

FIG. 5 illustrates a granular geometry representation obtained by the second approach, thus providing an input for e.g. a discrete ray tracing simulation algorithm. A voxel grid of a room is created and filled with the obtained point cloud from the depth-camera. Each voxel is defined as an occupied (contains point cloud data), or empty (does not contain point cloud data). Depending on the voxel type, different properties are assigned in order to define the behaviour of a sound ray when it reaches the voxel, e.g. reflection, diffraction, scattering, transmission etc. The voxel grid resolution defines the wanted level of details. A grid can be defined as a uniform grid when all space units are cubes of the same size but also as a hierarchical structure (k-d tree or octree). The latter one improves efficiency of the sound transmission module by speeding up the ray traversal algorithm.

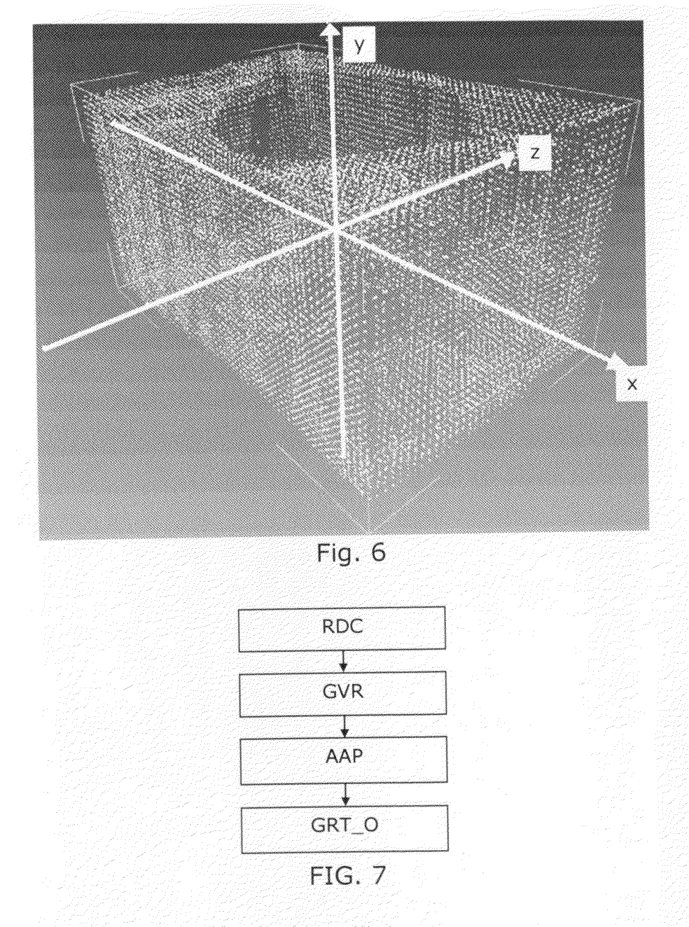

FIG. 6 shows a boundary of a room introduced after a cloud point representation of the room. This is introduced to generate a uniform voxel grid. The axes x, y, z represent a coordinate system with its origin where the scanning device was placed. In the following a specific example of a scanning and the following signal processing will be explained.

The room was scanned in order to obtain a point cloud description of the room boundaries and inner surfaces. The used equipment was: 1) Fujitsu Lifebook S Series, Intel Core i3 CPU M 370, 4×2.4 GHz, 4 GB RAM, running on 64 bit Ubuntu 12.04, 2) Kinect™ scanning device, and 3) Free software RGBDSIam [Ref: http://openslam.org/rgbdslam.html].

The software RGBDSIam allows quick acquisition of indoor scenes with a hand-held Kinect™ style camera or scanning device. It uses visual features known as SURF or SIFT to match pairs of acquired images, and uses RANSAC to robustly estimate the 3D transformation between them.

The Kinect™ was placed in the middle of the room and aligned with the room edges. The coordinates of all obtained points are relative to the device's starting position and orientation and the alignment has to be done in order to relate point cloud with the room coordinate system (length of the room—x axis, width—y axis and hight—z axis). Another option is to know in advance the position of the scanning device and orientation at the starting point, and than to correct the whole set of obtained data with this offset. When the first frame is recorded, the device is rotated by z and y axes in order to cover room interior as much as possible. While rotating the Kinect, the software maps new acquired scene to the previous one detecting “key points” in both scenes and aligning them at the same 3D model. The quality of the resulting model depends very much on this step—if the scenes are not matched in a good way, a flat surface can be represented in a “broken” or multiple planes which introduces errors for later processing and calculations. The result of Step 1 is a point cloud model of the room represented by .ply file format. Density of the points is very high (30202895 points in total) and the file itself is very heavy (1.3 GB of row text file).

In Step 2, the obtained .ply file is processed in order to reduce the amount of data. Using PCL and its voxel_grid library, the number of points is reduced to 17896. It has been done by octree structure with the leaf size of 0.1 m. Down sampling leads to less detailed model, but for many applications, details under 0.1 m precision do not play an important role in the acoustic simulation, even though in some applications a higher precision, with a resolution well below 0.1 m, can be important.

In Step 3, a sound transmission module used involves a discrete ray tracing algorithm [Ref: “Room simulation: A high-speed model for virtual audio”, Olesen, Soren Krarup. Proceedings of Nordic Acoustical Meeting, NAM'96, Helsinki, Finland, June 12-14, 1996. Finland, 1996. p. 339-342 and “An integer based ray-tracing algorithm”, Olesen, Søren Krarup. Proceedings of 100th Audio Engineering Society Convention, Copenhagen, May 11-14, 1996. 1996]. An input for this algorithm is a .txt file of voxel grid that represents room geometry. It defines witch voxel belongs to witch wall (boundary) and thus how the ray acts when specific voxel is reached. Based on this information the direction of the reflected ray is determined and it is traced since the receiver point is reached. Therefore, the output from the Step 2. is processed in order to meet the transmission module input format. The processing algorithm preferably involves following steps:
1) Two points are detected from the point cloud model: min and max. Min is defined as min x, min y and min z coordinates from the whole point cloud. Max is defined as max x, max y and max z from the whole point cloud.
2) A boundary box is created using min as a bottom left corner and max as a top right corner. It is divided into voxels giving the uniform voxel grid. Dimension of the voxel represents a resolution of the grid. FIG. 1 shows a boundary box filled with the point cloud model.
3) Each voxel is indexed and it's content is been examined: if the voxel contains points of the point cloud model, it is labelled as “occupied” if it doesn't contain any point it's labelled as “empty”.
4) Empty voxels represent air—ray can go through them with no interaction while occupied voxels represent surfaces that ray reflects from.
5) Each occupied voxel is examined by their neighbour voxels in order to determine the reflection type after a ray reaches it. If the voxel belongs to the group of voxels that represents a surface parallel with the x-axis it is labelled with X. The same approach is for Y and Z voxels. If the voxel has two or three labels at the same time (XY, YZ, XZ or XYZ) it is labelled as a corner—C. These labels allow to define specific interaction between ray and the voxel—the way how the ray reflects.
6) According to the voxel labels, a .txt file is created that can be directly used as an input for the sound transmission module.

The described method is capable of providing fast acquisition of the arbitrary room interior, not just the boundaries but also the inner surfaces. It is scalable and by changing the resolution of the uniform voxel grid high level of details can be provided, thus allowing application of advanced acoustic properties to the surface, thereby providing a realistic acoustic room model. The process is autonomous and the input to the sound transmission module can be generated directly from the room scan.

FIG. 7 shows steps of a method embodiment. The first step is to receive geometrical data from a 3D scanning device RDC in the form of raw measured data from the scanning device, or in a processed format, after having scanned a room. Next, a voxel representation is generated GVR in response to the received input data. Then, an acoustical property AAP is applied to the voxel elements of the voxel representation. In a simple version, a voxel is applied with the value “1”, if it represents an acoustically reflecting voxel, and “0” if it represent air, thus defining a simple voxel-based acoustical room model. Finally, a ray tracing algorithm is applied for calculating acoustical sound transmission in the room, e.g. form a source position to a receiver position, so as to generate a ray tracing output GRT_O based on the voxel-based acoustical room model.

To sum up, the invention provides a method for generating an output indicative of acoustical sound transmission in a room. By using e.g. a point cloud representation of an acoustic environment, it is possible to calculate its acoustics from the interior information obtained from the depth camera. This approach is suitable e.g. for run-time applications since it is not based on an audible excitation that can disturb running audio. Also, the point-cloud model can be updated in real time according to the scene changes detected by depth-camera. This allows efficient acoustical simulation of dynamic, interactive environments. Although only geometrical information of a room is provided, high amount of surface details leaves possibility for implementation of material recognition algorithms that involve semantic mapping. This can provide information of reflective properties of surfaces or objects at a point level. Also, a high amount of details allows a good approximation of complex geometries, e.g. porous materials, and rough surfaces, thus a more natural simulation of wave phenomena like diffraction and scattering is possible.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for generating an output indicative of acoustical sound transmission in a room, the method comprising:
receiving geometrical data representing a scanning of the room,
generating a numerical representation of the room in response to the geometrical data,
applying at least one acoustical property to elements of the numerical representation of the room to obtain an acoustical room model, and
- calculating the output indicative of the acoustical sound transmission in the room in response to the acoustical room model.

2-24. (canceled)

25. The method according to claim 1, wherein the numerical representation comprises a voxel-based representation comprising a plurality of voxels each being assigned with an acoustical property.

26. The method according to claim 1, wherein the acoustical property can be selected between at least two different values.

27. The method according to claim 1, comprising performing a segmentation in response to the geometrical data, so as to identify a plurality of objects in the room each comprising a plurality of elements of the numerical representation.

28. The method according to claim 1, comprising applying properties indicative of acoustical absorption to elements of the numerical representation of the room.

29. The method according to claim 28, comprising applying an image processing algorithm to geometrical data and/or a photo taken in the room, so as to automatically identify different objects in the room in accordance with parameters in the geometrical data and/or photo and to apply respective properties indicative of acoustical absorption to corresponding elements of the numerical representation of the room accordingly.

30. The method according to claim 1, wherein the calculating of the output indicative of the acoustical sound transmission in the room comprises calculating a statistical acoustical measure indicative of acoustical sound transmission in the room.

31. The method according to claim 1, wherein the calculating of the output indicative of the acoustical sound transmission in the room comprises generating an output indicative of an impulse response representing sound transmission from a source position to a receiver position in the room.

32. The method according to claim 1, wherein the output comprises data in a parametric format.

33. The method according to claim 1, comprising applying parameters indicative of acoustical diffusion and/or scattering to elements of the numerical representation of the room.

34. The method according to claim 1, comprising performing a discrete ray tracing algorithm in response to the acoustical room model.

35. The method according to claim 34, comprising receiving a stream of geometrical data representing respective scannings of the room, and dynamically updating a discrete ray tracing representation accordingly.

36. The method according to claim 1, comprising receiving a stream of position data indicative of an acoustical receiver position in the room, and dynamically calculating the output indicative of acoustical sound transmission from an acoustical source position to the acoustical receiver position in the room accordingly.

37. The method according to claim 1, comprising generating an acoustical output signal in response to a calculated acoustical sound transmission from a source position to a receiver position in the room, in accordance with the acoustical room model.

38. The method according to claim 37, comprising generating a binaural output signal in response to a calculated acoustical sound transmission from a source position to a receiver position an orientation in the room, in accordance with the acoustical room model.

39. The method according to claim 1, comprising applying a numerical method to the numerical representation of the room.

40. The method according to claim 1, comprising receiving the geometrical data from a scanning device together with a position where the scanning device was positioned in the room, when the geometrical data were measured.

41. The method according to claim 1, comprising receiving a plurality of geometrical data from a scanning device obtained at respective scanning positions in the room.

42. The method according to claim 1, comprising receiving the geometrical data from a scanning device being one of: an infrared depth sensor, a laser scanning device, an ultrasound scanning device, or a 3D camera.

43. A system comprising:
an input arranged to receive geometrical data representing a scanning of a room, and
a processor arranged:
to generate a numerical representation of the room in response to the geometrical data,
to apply at least one acoustical property to elements of the numerical representation of the room to obtain an acoustical room model, either by manually or automatically entering of data, and
to calculate an output indicative of the acoustical sound transmission in the room in response to the acoustical room model.
